(19) United States
(12) Patent Application Publication
(10) Pub. No.: US 2004/0044633 A1
(43) Pub. Date: Mar. 4, 2004

(54) System and method for solving an optimization problem using a neural-network-based genetic algorithm technique

(76) Inventor: Thomas W. Chen, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/231,760

(22) Filed: Aug. 29, 2002

(51) Int. Cl. G06N 3/08; G06G 7/00; G06E 3/00; G06E 1/00; G06F 15/18; G06N 3/12; G06N 3/00

(52) U.S. Cl. 706/13; 706/21; 706/25

(57) ABSTRACT

A system and method for solving a problem using a genetic algorithm technique is disclosed. A population of chromosomes that is representative of a set of candidate solutions of the problem is created and subjected to simulated evolution. A neural network is trained and employed to evaluate the fitness of the population of chromosomes. Based on the neural network evaluation, the population of chromosomes is updated.

### BACKGROUND OF THE INVENTION

1. Technical Field of the Invention

The present invention generally relates to evolutionary computation. More particularly, and not by way of any limitation, the present invention is directed to a system and method for solving an optimization problem using a genetic algorithm technique that employs a neural network.

2. Description of Related Art

Genetic algorithm (GA) techniques are employed to solve optimization problems that typically do not have precisely-defined solving methodologies, or if such methodologies exist, the methodologies are too time consuming. GA techniques are based on a biological metaphor of natural selection wherein problem-solving is viewed as a competition among a population of evolving candidate solutions. A fitness function evaluates each candidate solution in the population to decide whether or not it will contribute to the next generation of candidate solutions. Through operations analogous to gene transfer in asexual and sexual reproduction, the GA technique then creates a new population of candidate solutions.

Referring now to FIG. 1, depicted therein is a flow chart illustrating in further detail the various operations involved in a prior art method for solving an optimization problem using a GA technique. At block 100, the GA technique begins by creating a population of candidate solutions analogized as “chromosomes” that will be subjected to the principles of natural selection. At block 102, metaphorical GA operations, such as mutation and cross-linking, are performed on the chromosomes, i.e., the candidate solutions. At block 104, a new population is formed based on the genetic operations executed on the chromosomes. At block 106, each chromosome is evaluated for fitness by a fitness function. Typically, the fitness function comprises one or more analytical algorithms that evaluate a candidate solution's parametric values against a set of desired criteria. At block 108, based on the fitness evaluations performed by the fitness function, a portion of the chromosomes are selected to contribute to the next generation of chromosomes and the new population is updated (block 110). At decision block 112, if a solution has been found, then the solving method is complete. If a solution has not been found, however, the GA technique continues as shown by the return arrow to block 102. The illustrated GA technique continues iteratively until a solution is found.

It has been found, however, that the existing GA techniques are not without limitations. In particular, the operation of evaluating the “fitness” of the chromosomes of a population has proved to be time consuming. Each time the fitness of the chromosomes of a population is evaluated, the ad hoc analytical algorithms associated with the fitness function must perform a significant number of computations. To reduce the amount of number crunching, various evolutionary parameters have been modified. For example, the population size has been decreased in some instances, whereas the cross-linking rate and mutation rate have been increased in other instances. These modifications to the evolutionary parameters, however, have sacrificed quality and accuracy for run-time.

### SUMMARY OF THE INVENTION

A system and method for solving a problem using a genetic algorithm technique is disclosed. A population of chromosomes that is representative of a set of candidate solutions of the problem is created and subjected to simulated evolution. A neural network is trained and employed to evaluate the fitness of the population of chromosomes. Based on the neural network evaluation, the population of chromosomes is updated.

### BRIEF DESCRIPTION OF THE DRAWINGS

A more complete understanding of the present invention may be had by reference to the following Detailed Description when taken in conjunction with the accompanying drawings wherein:

FIG. 1 depicts a flow chart of the various operations involved in a prior art method for solving an optimization problem using a genetic algorithm technique;

FIG. 2 depicts a flow chart of the various operations involved in one embodiment of a method for solving an optimization problem using a genetic algorithm technique that employs a neural network;

FIG. 3 depicts a schematic diagram of one embodiment of a system for solving an optimization problem in accordance with the teachings of the present invention;

FIG. 4 depicts a flow chart of the various operations involved in a particular embodiment of the method shown in FIG. 2;

FIG. 5A depicts a training error graph that illustrates rate of convergence with respect to training a neural network; and

FIG. 5B depicts a phase transition diagram illustrating the various phases involved in one embodiment of a system and method for solving an optimization problem using a genetic algorithm technique that employs a neural network.

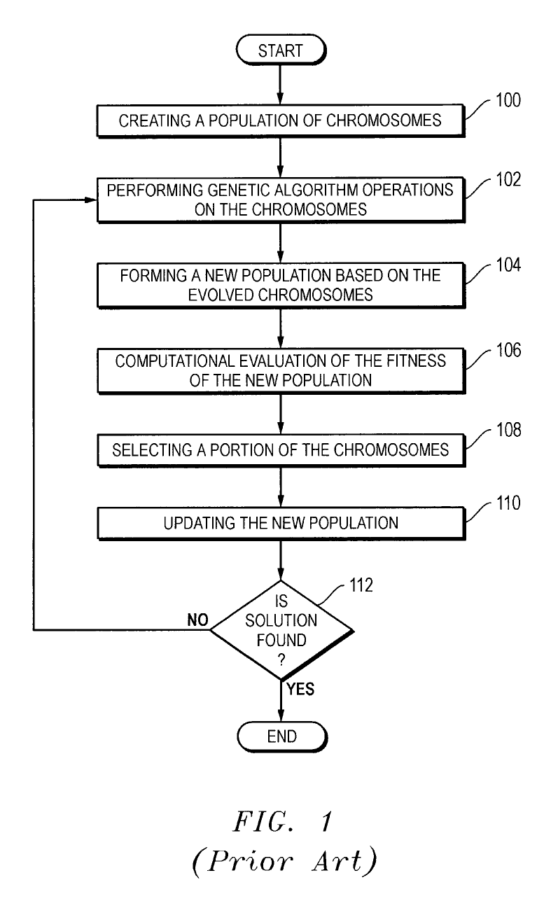

### DETAILED DESCRIPTION OF THE DRAWINGS

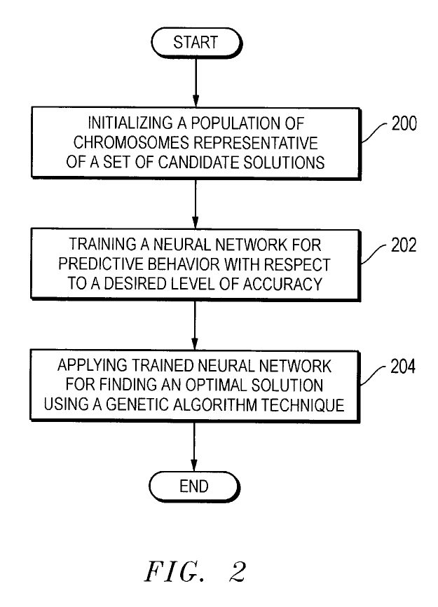

In the drawings, like or similar elements are designated with identical reference numerals throughout the several views thereof, and the various elements depicted are not necessarily drawn to scale. Referring now to FIG. 2, depicted therein is a flow chart of the various operations involved in one embodiment of a method for solving an optimization problem using a genetic algorithm technique that employs a neural network. At block 200, a population of chromosomes representative of a set of candidate solutions is initialized. In one embodiment, the chromosomes are randomly selected to ensure that the solution will be a global solution.

At block 202, a neural network is trained for predictive behavior with respect to a desired level of accuracy. The neural network may comprise a web of randomly connected electronic “neurons” that are capable of adaptive learning. The electronic neurons may take the form of a massively parallel distributed processor that has a natural propensity for storing experiential knowledge and making it available for use. Such a neural network may acquire knowledge through a learning process. In one embodiment the neural network comprises a feed-forward neural network having one or more inputs that are propagated through a variable number of hidden layers, each layer containing a variable number of nodes, which reach the output layer that contains one or more output nodes.

In another embodiment, the neural network may comprise a back-propagation neural network that comprises layers of parallel processing elements, called “neurons,” wherein each layer is fully connected to the proceeding layer by interconnection strengths, or synaptic weights. By varying the connection strengths (i.e., the synaptic weights), knowledge regarding a particular phenomenological problem may be stored. Learning involves initial estimated synaptic weight values being progressively corrected during a training process that compares predicted outputs to known outputs of a data set, and back-propagates any errors to determine the appropriate synaptic weight adjustments necessary to minimize the errors. This methodology may employ momentum back propagation rules or propagation rules based on other generalized rules. It should be appreciated, however, that although specific types of neural networks have been exemplified, any neural network that acquires, stores, and utilizes experiential knowledge for predictive evaluation is within the teachings of the present invention.

The data set employed to train the neural network may contain sample input parameters with the corresponding known outputs. The data set may be obtained from historical archived data in which the outcomes are known, or by creating sample data sets and solutions with the aid of an expert system. In one embodiment, the neural network is trained in real-time. Solution chromosomes being evaluated for fitness are provided to both a fitness function employing ad hoc analytical algorithms and the neural network. The fitness function computes the fitness of a chromosome and the neural network predicts the fitness of the chromosome. The fitness evaluation preformed by the fitness function serves as the training or feedback loop for the neural network, which may be performed iteratively until a desired level of accuracy is achieved.

Once the training process is complete, the network is able to predict fitness values for any arbitrary set of solution chromosomes without having to perform actual fitness algorithm computations. At block 204, the trained neural network is employed to find an optimal solution using a genetic algorithm (GA) technique. In one embodiment, the neural network evaluates the fitness of the chromosomes by a predictive methodology. The neural network's ability to approximate correct results for new cases that were not used for training make the neural network much faster than the intensive number crunching performed by the ad hoc algorithms. In another embodiment, the neural network evaluates the fitness of the chromosomes, but only identifies particularly unfit chromosomes. The fitness of the remaining chromosomes may be thereafter be computed by a select analytical algorithm. In this embodiment, the neural network decreases the load on the ad hoc analytical algorithms, thereby increasing the efficiency of the GA technique.

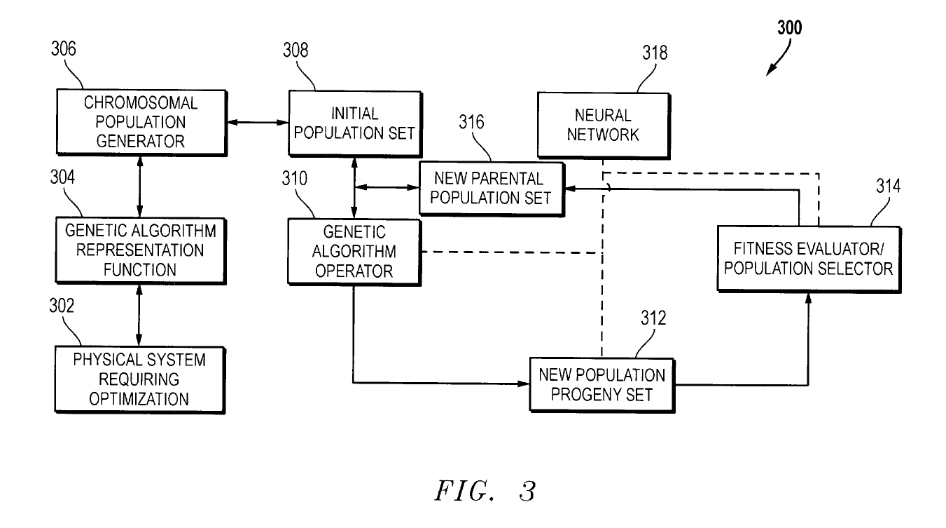

FIG. 3 depicts a schematic diagram of one embodiment of a system 300 for solving an optimization problem in accordance with the teachings of the present invention. A physical system 302 may be a system of any phenomenology that requires optimization. The system may be characterized by multiple and complex, even contradictory, constraints that must be satisfied. For example, the physical system 302 may comprise a Traveling Salesman Problem (TSP) where given a finite number of destinations and the cost of travel between each pair, the least expensive itinerary must be found wherein all the destinations are visited and the salesman returns to the starting point. By way of another exemplary application, the physical system 302 may comprise an integrated circuit wherein one or more constraints such as, e.g., clock speed, gate size and voltage, require parallel optimization.

A genetic algorithm representation function 304 maps the physical problem into a natural selection metaphor where a fitness function is to be optimized in an n-dimensional hyperspace. A chromosomal population generator 306 generates an initial population set 308 of solution chromosomes that represent candidate solutions based on the criteria formed by the GA representation function 304. Any one of a variety of chromosomal encoding techniques may be employed to initiate the chromosomes. One common method of encoding chromosomes is a binary string technique wherein each chromosome is a string of bits, a 0 or a 1, that represent a candidate solution. Alternatively, permutation coding may be employed wherein each chromosome is a string of numbers in a sequence. In value coding, each chromosome is a string of values. The values may be anything related to the problem such as form numbers, functions, characters, or complicated objects. In tree encoding, each chromosome is a tree of some objects, such as functions or commands. It should be apparent to those skilled in the art that the type of encoding implemented will depend on the nature of the problem. For example, the aforementioned TSP may employ permutation encoding. Likewise, an IC gate sizing problem may employ a value coding technique. Moreover, it should be appreciated that the coding schemes mentioned are by way of example only and not by way of limitation. Other encoding schemes may be employed and are within the teachings of the present invention.

A genetic algorithm operator 310 simulates natural selection by executing one or more GA operations on the initial population set 308. The GA operations may include crossover, linkage, and mutation, for example, and create a new population progeny set 312 that may comprise genetically different offspring of the same species. In one embodiment of crossover, chromosomal material between homologous chromosomes is interchanged by a process of breakage and reunion. In one embodiment of linkage, a condition is created wherein two or more portions of a chromosome tend to be inherited together. Linked portions of a chromosome do not assort independently, but can be separated by crossing-over. In one embodiment of mutation, the data in a random portion of a chromosome is altered or mutated. Moreover, the GA operations may include assortative and nonassortative mating. Assortative mating is the nonrandom recombination between two chromosomes and nonassortative mating is the random recombination of chromosomes.

A fitness evaluator/population selector 314 evaluates the fitness of the chromosomes in the new population progeny set. Based on the fitness evaluation, the fitness evaluator/population selector 314 selects a portion of the solution chromosomes to continue as the next generation's new parental population set 316. The fitness evaluator/population selector may employ ad hoc algorithms, a neural network 318, or any combination thereof. As discussed, in one embodiment, a trained neural network may evaluate the chromosomal fitness of all the chromosomes.

During the training phase, the neural network 318 monitors the new population progeny set 312 and predicts the fitness of the solution chromosomes therein. In parallel, the fitness evaluator/population selector 314 evaluates the fitness of the chromosomes using an algorithm that is specific to the underlying physical phenomenon. The fitness evaluator/population selector 314 thereby provides supervised learning and adaptive feedback to the neural network 318. Once the neural network is trained, in one embodiment, the neural network 318 is operable to provide a prediction as to whether a newly generated chromosome is fit enough to go through the costly evaluation process, or it should be rejected outright.

Once the fitness of the solution chromosomes has been determined, fitness evaluator/population selector 314 selects chromosomes to continue on to the next generation. Selection algorithms include, for example, roulette wheel selection functions, Boltzman selection functions, steady-state functions, and tournament selection functions. For instance, in roulette wheel selection, the chances of being selected for the next generation are proportional to the fitness evaluation, that is, the greater the relative fitness evaluation, the greater the chances of being selected. In steady-state selection functions, a portion of the chromosomes in the population are selected based upon high fitness. These chromosomes continue on to the next generation along with their offspring. Steady-state selection employs elitism wherein the chromosomes with the highest fitness are reproduced asexually. The idea of elitism is that when creating a new population of chromosomes by crossover and mutation, for example, a large chance exists of losing the fittest chromosome. It will be understood by those skilled in the art that the aforementioned selection techniques are presented by way of example and not by way of limitation; other selection techniques should therefore be deemed to be within the teachings of the present invention. The natural selection cycle represented by the genetic algorithm operator 310, new population progeny set 312, fitness evaluator/population selector 314, and new population progeny set 316 continues until a global optimal solution is generated.

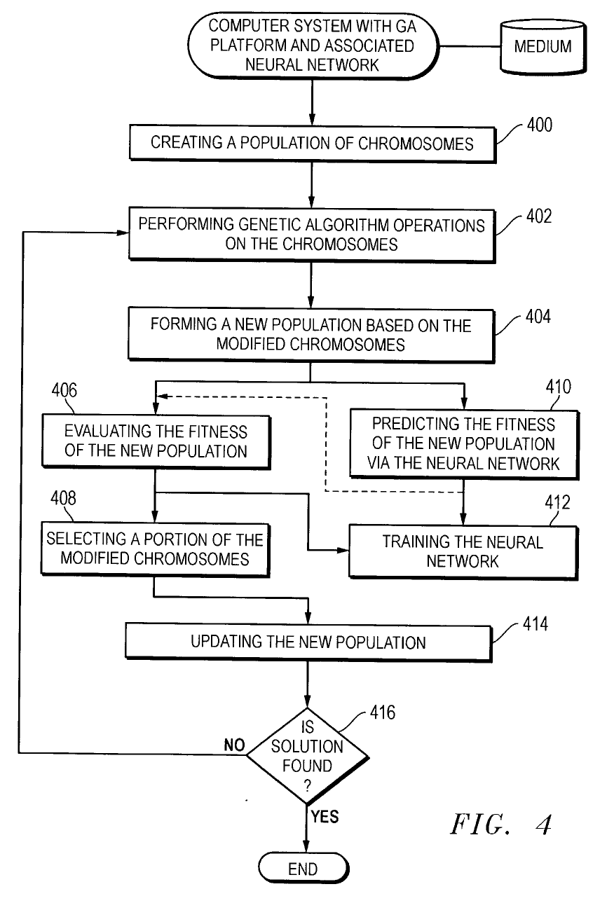

A flow chart of the various operations involved in a particular embodiment of the scheme set forth above is illustrated in FIG. 4. At block 400, the GA technique begins by creating a population of chromosomes that will be subjected to a simulated evolution of species by natural selection. The optimal size of the population will depend on multiple factors including type of encoding employed and the size of the solution space. At block 402, the aforementioned GA operations, such as mutation and cross-linking, are performed on the solution chromosomes. The evolutionary rate of the mutation, cross-linking or other variable may be optimized during this operation.

At block 404, a new population is formed based on the genetic operations executed on the chromosomes. At block 406, each chromosome is evaluated for fitness by a fitness function having one or more analytical algorithms, a neural network, or any combination thereof. At block 408, based on the fitness evaluations performed by the fitness function, a portion of the chromosomes are selected to contribute to the next generation of chromosomes.

As previously discussed in detail, the analytical algorithms relating to the fitness function serve as a training loop for the adaptive learning of the neural network. As illustrated at block 410, the fitness of the population is predicted by the neural network and the neural network is trained (block 412). The neural network training may occur at different times during the GA process. For example, the training may occur initially to teach the neural network, which thereafter is used to winnow out the less fit solution chromosomes from the fitness evaluation process (as shown by the broken return path arrow between blocks 410 and 406). Additionally, neural network training may occur later in the GA process to reinforce the learning of the neural network.

At block 414, the new population is updated based on the selection operations at block 408. At decision block 416, if a solution has been found, then the GA-based optimization process flow ends. The solution detection methodology may be based on a variety of factors including the convergence of the candidate solution, acceptable levels of error, and the variance between chromosomes, for example. If a solution has not been found, however, the GA process continues as shown by the return arrow to block 402. Accordingly, the illustrated GA technique may continue iteratively until a solution is found or some other termination criterion is reached. With each iteration or epoch, the natural selection process produces more fit chromosomes, that is, the natural selection process produces candidate solutions that closely approximate a globally unique, optimal solution.

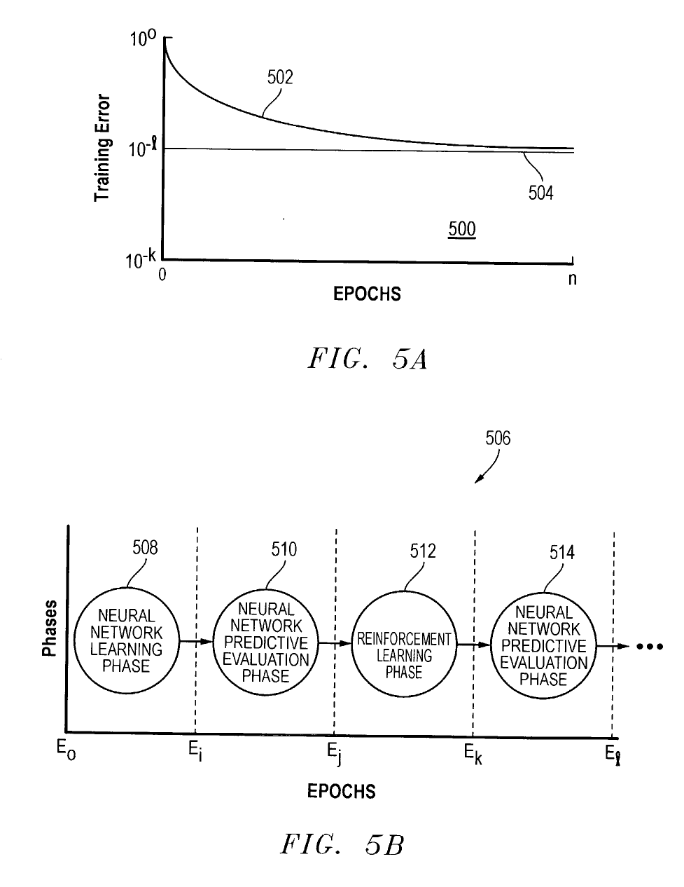

Referring now to FIG. 5A, depicted therein is a training error graph 500 that illustrates the rate of convergence with respect to training a neural network in an embodiment of the present invention. The x-axis illustrates the number of epochs, {0,n}, that have occurred. Each epoch may represent an iteration wherein the neural network is presented with new input data. The y-axis illustrates the training error {₁₀^{-k}, 10₀}. Curve 502 illustrates the training error as a function of epochs; as the number of epochs increases, the curve 502 approaches an asymptote 504. That is, as the number of epochs increases, the error in the neural network's prediction approaches an asymptotical value. The desired level of accuracy of the neural network and cumulative cost of successive epochs may therefore ultimately determine the duration of the training of the neural network. It should be understood that the training error graph 500 is illustrative of one embodiment of the training behavior of neural networks; other training behaviors are within the scope of the present invention.

FIG. 5B depicts a phase transition diagram 506 illustrating the various phases involved in one embodiment of a system and method for solving an optimization problem using a genetic algorithm technique that employs a neural network. The x-axis illustrates time as epoches {Eₒ, Eₗ, Eⱼ, Eₖ, Eₗ, . . . }. Between epochs Eₒ and Eₗ, the neural network of the genetic algorithm technique of the present invention is in the learning phase 508. Thereafter, between epochs Eᵢ and Eⱼ, the neural network is in the predictive evaluation phase 510. The neural network transitions into the reinforcement learning phase 512 after epoch Eⱼ. Between epochs Eₖ and Eₗ, the neural network is back in the predictive evaluation phase 514. At epoch Eₗ, the neural network may be continue in the evaluation phase or re-enter a reinforcement learning phase. It should be apparent that once the neural network is trained in a learning phase, the neural network may continue alternating between the evaluation and reinforcement learning phases until a solution is found. The precise sequence of phases of a neural network may vary and will depend on the desired level of accuracy of the neural network.

Based on the foregoing, it should be appreciated that the present invention provides an innovative system and method for solving optimization problems using a GA technique by employing an adaptive-predicative neural network. Through adaptive learning the neural network is capable of predictive evaluation of the fitness of chromosomes without having to perform extensive computations, thereby increasing the efficiency of the GA technique.

Although the invention has been described with reference to certain illustrations, it is to be understood that the forms of the invention shown and described are to be treated as exemplary embodiments only. Various changes, substitutions and modifications can be realized without departing from the spirit and scope of the invention as defined by the appended claims.

What is claimed is:

1. A method for solving a problem using a genetic algorithm technique, comprising:
initializing a population of chromosomes representative of a set of candidate solutions to said problem;
training a neural network for fitness prediction with respect to said population of chromosomes; and
applying said trained neural network for finding an optimal solution to said optimization problem, wherein said trained neural network is used for evaluating fitness of each successive generation of chromosomes obtained as a result of a genetic operation.

2. The method as recited in claim 1, wherein a portion of said population of chromosomes representative of said set of candidate solutions comprises a randomly-generated population of chromosomes.

3. The method as recited in claim 1, wherein the step of training a neural network for fitness prediction further comprises training said neural network until the fitness prediction of said neural network asymptotically approaches a predetermined level of accuracy.

4. The method as recited in claim 1, further comprising the step of periodically reinforcing said training of said neural network for fitness prediction with respect to said population of chromosomes.

5. A method for solving an optimization problem using a genetic algorithm technique, comprising:
creating a population of chromosomes representative of a set of candidate solutions of said optimization problem;
performing genetic algorithm operations on said chromosomes to form a new population of chromosomes;
evaluating the fitness of said new population of chromosomes with a neural network; and
updating said new population of chromosomes based on the neural network evaluation.

6. The method as recited in claim 5, wherein said genetic algorithm operations are selected from the group consisting of cross-linking operations, linking operations, and mutation operations.

7. The method as recited in claim 6, further comprising adjusting an evolutionary variable selected from the group consisting of rate of cross-linking operations and rate of mutation operations.

8. The method as recited in claim 5, wherein said neural network comprises a back propagation neural network.

9. The method as recited in claim 5, further comprising the step of training said neural network for fitness evaluation by comparing a neural network prediction and an analytical solution.

10. The method as recited in claim 9, wherein said training comprises neural network learning.

11. The method as recited in claim 9, wherein said training comprises neural network reenforcement learning.

12. A computer-accessible medium having instructions for solving an optimization problem using a genetic algorithm technique operable to be executed on a computer system, said instructions which, when executed on said computer system, perform the steps:
creating a population of chromosomes representative of a set of candidate solutions of said optimization problem;
performing genetic algorithm operations on said chromosomes to form a new population of chromosomes;
evaluating the fitness of said new population of chromosomes with a neural network; and
updating said new population of chromosomes based on the neural network evaluation.

13. The computer-accessible medium as recited in claim 12, wherein said genetic algorithm operations are selected from the group consisting of cross-linking operations, linking operations, and mutation operations.

14. The computer-accessible medium as recited in claim 13, further comprising instructions for adjusting an evolutionary variable selected from the group consisting of rate of cross-linking operations and rate of mutation operations.

15. The computer-accessible medium as recited in claim 12, wherein said neural network comprises a back propagation neural network.

16. The computer-accessible medium as recited in claim 12, further comprising instructions for training said neural network for fitness evaluation by comparing a neural network prediction and an analytical solution.

17. The computer-accessible medium as recited in claim 16, wherein said training comprises neural network learning.

18. The computer-accessible medium as recited in claim 16, wherein said training comprises neural network reenforcement learning.

19. A system for solving a problem using a genetic algorithm technique, comprising:
means for generating successive populations of chromosomes representative of a set of candidate solutions to said problem;
means for training a neural network for fitness with respect to said successive populations of chromosomes; and
means for applying said trained neural network for finding an optimal solution to said problem, wherein said trained neural network is used for evaluating fitness of each said successive generation of chromosomes.

20. The system as recited in claim 19, wherein said means for training a neural network for fitness with respect to said successive populations of chromosomes further comprises means for training said neural network until said neural network's predictive accuracy asymptotically approaches a predetermined level of accuracy.

21. The system as recited in claim 19, wherein each of said successive generation of chromosomes is obtained as a result of a genetic operation.

22. The system as recited in claim 19, wherein said neural network comprises a back propagation neural network.

23. The system as recited in claim 19, wherein said neural network comprises a feed-forward neural network.

24. The method as recited in claim 19, wherein said training means comprises neural network learning means.

25. The method as recited in claim 19, wherein said training means comprises neural network reenforcement learning means.
